(19) United States
(12) Patent Application Publication
(10) Pub. No.: US 2023/0351771 A1
(43) Pub. Date: Nov. 2, 2023

(54) METHOD FOR ASCERTAINING A DYNAMIC FOREIGN OBJECT-DRIVING CORRIDOR ASSOCIATION

(71) Applicant: Robert Bosch GmbH, Stuttgart (DE)

(72) Inventors: Alexander Lengsfeld, Bad Muender (DE); Daniel Stopper, Tuebingen (DE); Matthias Christof Lamparter, Renningen (DE); Philip Lenz, Holle (DE)

(21) Appl. No.: 18/185,594

(22) Filed: Mar. 17, 2023

(30) Foreign Application Priority Data
Apr. 27, 2022 (DE) 10 2022 204 086.4

(51) Int. Cl. G06V 20/58; G06T 7/20

(52) U.S. Cl. CPC G06V 20/58; G06T 7/20; B60W 30/08

(57) ABSTRACT

A method for ascertaining a dynamic foreign object-driving corridor association with the aid of an image sensor of an ego vehicle, in which images of the environment of the ego vehicle are generated with the aid of the image sensor. A driving corridor of the ego vehicle is ascertained with the aid of the images in the native measuring space of the image sensor from roadway information and/or with the aid of the odometry of the ego vehicle, foreign objects are detected, and at least one kinematic variable is ascertained for at least one of the foreign objects, and at least one dynamic foreign object-driving corridor association for the lateral movement of the foreign object relative to the driving corridor is ascertained based on the at least one kinematic variable and the driving corridor.

### CROSS REFERENCE

The present application claims the benefit under 35 U.S.C. § 119 of German Patent Application No. DE 10 2022 204 086.4 filed on Apr. 27, 2022, which is expressly incorporated herein by reference in its entirety.

### FIELD

The present invention relates to a method for ascertaining a dynamic foreign object-driving corridor association with the aid of an image sensor of an ego vehicle. In addition, the present invention relates to a computer program product which is designed to execute the present method.

### BACKGROUND INFORMATION

The environment detection of motor vehicles plays an ever-greater role. It is particularly important for assisting a vehicle driver of the ego vehicle while driving and/or in driving the motor vehicle in an at least semiautonomous manner.

Generally, the detection of the environment of the motor vehicle as well as its analysis is usually accomplished with the aid of sensors of the ego vehicle. Image sensors and/or radar-based sensors are usually among these sensors.

U.S. Patent Application Publication No. US 2019/0122559 A1, describes using image sensors and also classification methods and neural networks to detect not only foreign objects but also optical roadway markings and roadway boundaries.

German Patent Application No. DE 10 2019 208 507 A1 describes generating images of the environment of the ego vehicle with the aid of an image sensor of an ego vehicle and analyzing the environment of the ego vehicle in the native measuring space of the image sensor.

### SUMMARY

An object of the present invention is to provide improved or at least other embodiments for a method for analyzing the environment of an ego vehicle and a computer program product for executing the method, which especially remedy the disadvantages of the related art. More specifically, an object of the present invention includes providing embodiments that are characterized by greater safety and/or robustness for the present method and for the computer program product.

According to the present invention, this object may be achieved by features of the present invention. Advantageous embodiments of the present invention are disclosed herein.

The present invention is based on the general idea of using an image sensor for the analysis of the environment of an ego vehicle, and thereby ascertaining, with the aid of the images and in the native measuring space of the image sensor, dynamic behaviors of foreign objects relative to the environment topology. The consideration of dynamic behaviors of the foreign objects leads to an overall improved full analysis of the environment in which movements of foreign objects relative to the ego vehicle are detected at least at a reduced effort. This results in greater safety in the operation of the ego vehicle. The execution of the present method in the native measuring space of the image sensor, that is, in the two-dimensional image plane of the images, has the result that transformations from the native measuring space into other coordinates, e.g., into three-dimensional coordinates, are omitted or at least reduced, which means that related errors and inaccuracies are likewise omitted or at least reduced. This leads to a greater robustness and thus reliability of the analysis of the environment of the ego vehicle.

In accordance with an example embodiment of the present invention, a dynamic association between a driving corridor of the ego vehicle and at least one foreign object is ascertained in the analysis of the environment with the aid of images of the image sensor. In the following text, this dynamic association is also referred to as a dynamic foreign object-driving corridor association. In the process, images of the environment of the ego vehicle are generated with the aid of the image sensor. Using the images and/or the odometry of the ego vehicle and in the native measuring space of the image sensor, a driving corridor of the ego vehicle along which the ego vehicle will move is ascertained in addition. Moreover, foreign objects are detected with the aid of the images and in the native measuring space of the image sensor. Furthermore, at least one kinematic variable is ascertained for at least one of the foreign objects with the aid of the images and in the native measuring space of the image sensor. Based on the at least one kinematic variable and the driving corridor, at least one dynamic foreign object-driving corridor association for the lateral movement of the foreign object relative to the driving corridor is ascertained.

For practical purposes, the dynamic foreign object-driving corridor association describes and/or includes the lateral movement of the foreign object relative to the driving corridor.

The dynamic foreign object-driving corridor association expediently also encompasses a static association between foreign objects and the driving corridor. This is the case especially if no relative movement is present between the driving corridor and the foreign object. For example, such a static association may be present with a third-party vehicle which is static with regard to the ego vehicle, in particular traveling in front at the same speed.

As described above, the driving corridor of the ego vehicle is ascertained based on roadway information. Among this roadway information, for example, are optical restrictions of a normally static roadway and/or lateral boundary objects which restrict the roadway such as guardrails, which will generally be referred to as boundaries in the following text.

The images and the odometry of the ego vehicle are preferably used to ascertain the driving corridor of the ego vehicle. In other words, the driving corridor of the ego vehicle is preferably ascertained with the aid of the images and in the native measuring space of the image sensor, using roadway information and with the aid of the odometry of the ego vehicle. This results in a more accurate ascertainment of the driving corridor and furthermore makes it possible to ascertain a driving corridor when required roadway information is temporarily not available or available only to an insufficient extent and/or at an insufficient quality. The robustness of the method is therefore increased.

The roadway information, in particular the driving corridor, may be available in the native measuring space basically in various ways.

In an advantageous manner, input data for roadway information, and thus also for the driving corridor, is available in point lists or as polygon chains, generally also known as “splines”, which describe the roadway extension and thus also the driving corridor in corresponding image coordinates. This information usually reflects the static roadway topology. Roadway information and especially the driving corridor are thus provided in an uncomplicated way in the native measuring space of the image sensor. This leads to a reduction of possible errors in the analysis, especially when ascertaining the dynamic association, and also to a simplified, resource-sparing execution of the present method.

Foreign objects may be of any type.

Foreign objects that move on their own are preferably detected as such objects. Among these are especially other road users such as third-party vehicles and persons, especially pedestrians.

The detection of foreign objects may basically be carried out in a variety of ways. It is possible to use neural networks and/or object classifications for detecting foreign objects.

Information pertaining to foreign objects may be available in the native measuring space in a variety of forms.

Foreign objects are advantageously represented by what is generally known as bounding boxes, which provide the position and extension of the associated foreign object in image coordinates. The foreign objects are therefore provided in an uncomplicated manner in the native measuring space of the image sensor. This subsequently reduces possible errors in the analysis, especially when ascertaining the dynamic association.

In addition, it simplifies the execution of the present method in a resource-sparing manner.

As an alternative or in addition, it is possible to detect and/or represent foreign objects by their forms using semantic segmentation methods.

The at least one kinematic variable of the foreign object may basically be one such type.

According to an example embodiment of the present invention, a velocity of the foreign object relative to the ego vehicle is preferably ascertained as a kinematic variable of the foreign object. A lateral velocity of the foreign object relative to the driving corridor of the ego vehicle is preferably ascertained as a kinematic variable of the foreign object. The lateral velocity in particular is the velocity transversely or at an angle with respect to the driving corridor, in particular to a boundary of the driving corridor.

In an advantageous manner, according to an example embodiment of the present invention, a distance of the foreign object from the driving corridor, in particular from optical boundaries of the driving corridor such as roadway markings, is ascertained as a kinematic variable of the foreign object. This may be the lateral distance of the foreign object from the driving corridor, in particular from the boundary of the driving corridor.

The ascertaining of the distance is able to be accomplished by measuring the distance in pixels between the acquired polygon chains or splines and the bounding box of the associated foreign object. A resource-sparing, simple and robust ascertainment of the distance is thereby provided.

Using the ascertained distance of the respective foreign object and based on its absolute positions in the image, a static association in the native measuring space is advantageously ascertained for all acquired foreign objects. A core variable in this context may be the calculation of an overlap measure, normalized between 0 and 1, of the bounding boxes with a driving corridor, as described in German Patent Application No. DE 10 2019 208 507 A1.

In an advantageous manner, according to an example embodiment of the present invention, a movement direction of the foreign object is ascertained as a kinematic variable of the foreign object. More specifically, the lateral movement of the foreign object relative to the driving corridor, in particular relative to a boundary of the driving corridor, is preferably ascertained in the process.

A simplified and robust ascertainment of the lateral velocity is achievable by tracking the movement of the bounding box associated with the foreign object over time and ascertaining the lateral velocity of the foreign object relative to the driving corridor from the movement.

Similarly, the tracking of the bounding box over time makes it possible to ascertain the movement direction of the foreign object in a simple and robust manner.

As an alternative or in addition, it is possible to use the optical flow, in particular of the associated bounding box, to ascertain at least one of the at least one the kinematic variables.

Embodiments of the present invention in which an ego movement of the ego vehicle is taken into account for ascertaining at least one of the at least one kinematic variables and/or at least one of the at least one dynamic associations are considered to be advantageous. This leads to a greater robustness and thus reliability in the ascertainment of the kinematic variables and/or the dynamic association.

The ego movement of the ego vehicle preferably includes both translatory and rotatory movements of the ego vehicle.

The ego movement of the ego vehicle is preferably ascertained with the aid of the images and in the native measuring space of the image sensor and/or with the aid of the odometry of the ego vehicle. This results in a further reduction of possible errors and thus in a greater robustness. In addition, the method is thereby able to be carried out in a simplified and resource-sparing manner.

According to an example embodiment of the present invention, at least one kinematic variable such as the velocity and/or the movement direction of the foreign object is ascertained in the native measuring space, preferably by deriving a velocity signal from the movement of the bounding box associated with the foreign object in the image plane and thus in the native measuring space over the time. Factoring out the ego movement of the ego vehicle, the relative movements of the foreign object with respect to the driving corridor are then ascertained, in particular with respect to the boundaries of the driving corridor.

In an advantageous manner, a dynamic foreign object-driving corridor association is a period during which a foreign object which is located outside of the driving corridor enters the driving corridor. In English, this period is also known as a ‘time-to-enter corridor’, abbreviated as “TTEC”, and referred to as such in the following text.

According to an example embodiment of the present invention, to ascertain the time-to-enter corridor, the distance of the foreign object from the driving corridor is related to the velocity of the foreign object, preferably to the lateral velocity. Given a simple and uniform movement of the foreign object, the following thus results for the time-to-enter corridor:

$$T T E C = \frac{d}{{v}_{l}} ,$$

$$T T E C = \frac{d}{{v}_{l}} ,$$

where d is the distance of the foreign object from the driving corridor, and vₗ is the lateral velocity of the foreign object. This leads to a simple and robust ascertainment of the time-to-enter corridor as a dynamic foreign object-driving corridor association.

A dynamic foreign object-driving corridor association is advantageously a period during which a foreign object which is located within the driving corridor leaves the driving corridor. Hereinafter, this period is also referred to by its English name “time-to-leave corridor”, abbreviated as “TTLC”.

As in the ascertainment of the time-to-enter corridor, to ascertain the time-to-leave corridor, the distance of the foreign object from the driving corridor is related to the velocity, preferably to the lateral velocity, of the foreign object. Given a simple and uniform movement of the foreign object, the following thus results for the time-to-leave corridor:

$$T T L C = \frac{d}{{v}_{l}} ,$$

where d is once again the distance of the foreign object from a boundary of the driving corridor, and vₗ is the lateral velocity. As a result, the time-to-leave corridor is ascertained in a simple and robust manner as a dynamic foreign object-driving corridor association.

$$T T L C = \frac{d}{{v}_{l}} ,$$

It is possible to derive a probability from at least one of the at least one dynamic associations, or as one such dynamic association.

In particular, it is possible to ascertain a probability of the foreign object entering the driving corridor from the time-to-enter corridor and/or a probability of the foreign object leaving the driving corridor from the time-to-leave corridor.

Further information, in particular in connection with the foreign object and/or the traffic situation, is utilized to ascertain the probability.

More specifically, at least one geometrical variable of the foreign object such as an angle between a predicted object trajectory of the foreign object and the driving corridor, in particular boundaries of the driving corridor, is used.

It is possible to subject the respective probability, in particular the entry probability and/or the exit probability, to a plausibility check. The plausibility check advantageously considers road user intentions, for instance the use of a lane-change signal of a third-party vehicle and the like.

The at least one ascertained kinematic variable and/or dynamic foreign object-driving corridor association is advantageously made available to a driver assistance system of the ego vehicle. The driver assistance system considers the at least one kinematic variable and/or the dynamic association in making the decision in connection with the driver assistance.

In the process, the driver assistance system is able to be used, and equipped for such a purpose, both for assisting a vehicle driver and for the at least semiautonomous driving of the ego vehicle.

The driver assistance system may include an adaptive cruise control and/or an autonomous emergency brake function, for example.

Overall, an evaluation of the scenery in the native measuring space of the image sensor is able to be carried out in the present method. This includes detectable foreign objects together with the ascertainment of at least one kinematic variable of at least one foreign object. The determination of tracks and boundaries of the drivable area are also among them. By fusing different algorithms, the entire roadway topology including the driving corridor is preferably ascertained in the native measuring space of the image sensor.

According to an example embodiment of the present invention, a fusion of objects from a classification result and a generic detection result is advantageously used for detecting foreign objects.

Next, a fusion of the foreign objects and the driving corridor advantageously takes place for the static association between the driving corridor and the foreign objects in the native measuring space of the image sensor.

The ascertainment of at least one dynamic foreign object-driving corridor association is preferably carried out in the native measuring space of the image sensor. Among these are, for instance, the time-to-enter corridor or TTEC for the timely detection of foreign objects that most likely will enter the driving corridor. As an alternative or in addition, the time-to-leave corridor, abbreviated as TTLC, for the timely detection of foreign objects that will likely depart from the driving corridor is part of this.

It is also possible to ascertain an entry probability and/or exit probabilities.

It is possible to use a fusion module to supply information to downstream functions having different requirements, e.g., the vehicle assistance system.

In the preceding text it is assumed for the sake of simplicity that the ego vehicle has a single image sensor. It is understood that the ego vehicle may also include two or more image sensors which generate images in each case, and that the method is carried out in a similar manner with the images of the two or more image sensors.

The respective image sensor is usually part of a camera of the ego vehicle.

It is furthermore understood that the ego vehicle may also have further sensors such as at least one radar sensor, in which case the present method can then be expanded accordingly.

It is understood that the ascertained variables and/or associations, especially if sensors that operate in three dimensions are available such as radar sensors, can be subjected to a transformation and, for example, be used in a three-dimensional space.

The method according to the present invention is advantageously carried out with the aid of a computer program product, which is configured accordingly.

The computer program product advantageously includes instructions that can be read out by a computer system such that the computer system carries out the present method when the computer program product is executed.

The computer program product is advantageously stored on a memory system which includes at least one non-volatile memory.

The computer program product advantageously includes instructions that induce the ego vehicle, in particular the control device, to execute the method.

The computer program product may at least in part be stored in the ego vehicle. The ego vehicle may have an appropriately configured control device to carry out the computer program product.

It is understood that the scope of the present invention also encompasses the computer program product.

Further important features and advantages of the present invention are disclosed herein.

It is understood that the above-mentioned features and the features still to be described in the following text are able to be used not only in the indicated combination but also in other combinations or on their own without departing from the scope of the present invention.

Preferred exemplary embodiments of the present invention are shown in the figures and will be described in greater detail in the following description, where the same reference numerals refer to identical or similar or functionally equivalent components.

### BRIEF DESCRIPTION OF THE DRAWINGS

FIG. 1 shows a greatly simplified representation of a motor vehicle having an image sensor.

FIG. 2 shows an image recorded with the aid of the image sensor.

FIG. 3 shows a flow diagram to describe a method for ascertaining a dynamic foreign object-driving corridor association with the aid of the images generated by the image sensor, according to an example embodiment of the present invention.

### DETAILED DESCRIPTION OF EXAMPLE EMBODIMENTS

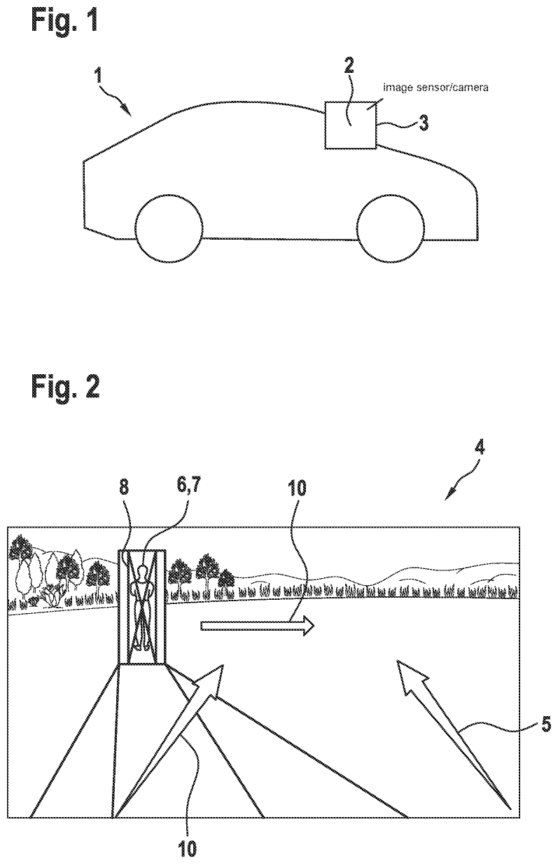

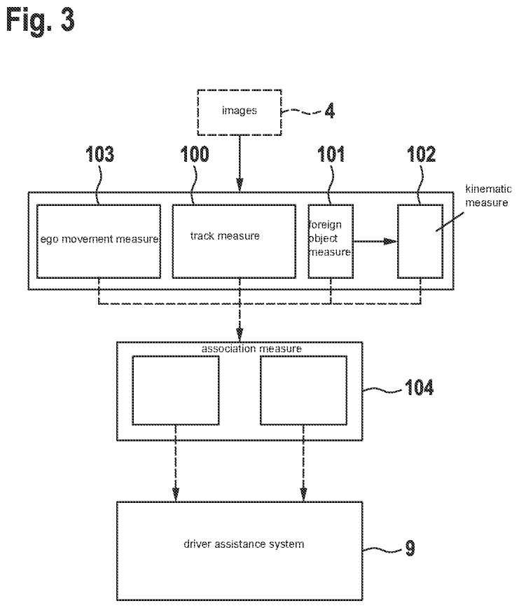

A motor vehicle 1, as shown in simplified form in FIG. 1, has at least one image sensor 2. In the exemplary embodiment illustrated in FIG. 1, it is assumed for the sake of simplicity that motor vehicle 1 has a single such image sensor 2. In the illustrated exemplary embodiment, image sensor 2 is part of a camera 3. While in operation, image sensor 2 generates images 4 of the environment of motor vehicle 1 (compare FIGS. 2 and 3). With the aid of these images 4, a dynamic association between a driving corridor 5 of motor vehicle 1 and foreign objects 6 is ascertained according to the method described in the following text. Motor vehicle 1 thus is ego vehicle 1. Hereinafter, the dynamic association will also be referred to as a dynamic foreign object-driving corridor association.

FIG. 2 shows an image 4 from image sensor 2 to which information has been inserted in addition. FIG. 3 shows a flow diagram to describe the method.

As may be gathered from FIGS. 2 and 3, images 4 are utilized to ascertain the dynamic foreign object-driving corridor association, and such an image 4 is symbolically shown in FIG. 4 by dashed lines. The detection of foreign objects 6 and the ascertainment of driving corridor 5 as well as the kinematics of foreign objects 6 take place with the aid of images 4 and in the native measuring space of image sensor 2, and thus in the two-dimensional image plane. To ascertain the dynamic association, driving corridor 5 of ego vehicle 1 is ascertained from roadway information with the aid of images 4 from image sensor 2 and in the native measuring space of image sensor 2. Driving corridor 5 is the particular corridor 5 along which ego vehicle 1 will move. As a rule, driving corridor 5 is restricted by roadway boundaries, which are not shown, as roadway information and/or is able to be estimated from the kinematic movement of ego vehicle 1 and thus the odometry of ego vehicle 1. In addition, foreign objects 6 are detected with the aid of images 4 from image sensor 2 and in the native measuring space of image sensor 2. For the sake of simplicity, a single foreign object 6 can be seen in the example shown in FIG. 2. To simplify matters, it is also assumed hereinafter that this single foreign object 6 is detected in images 4 to simplify matters. The foreign object involves a foreign object 6 that moves on its own accord. Purely by way of example, foreign object 6 is a person 7. A not depicted third-party vehicle may likewise be a foreign object 6. In addition, at least one kinematic variable is ascertained with the aid of images 4 from image sensor 2 and in the native measuring space from image sensor 2 for at least one of foreign objects 6, which is the only foreign object 6 in the illustrated exemplary embodiment. Based on the at least one kinematic variable and driving corridor 5, at least one dynamic foreign object-driving corridor association for the lateral movement of foreign object 6 relative to driving corridor 5 will then be ascertained. The dynamic foreign object-driving corridor association thus describes and/or encompasses the lateral movement of foreign object 6 relative to driving corridor 5. The dynamic foreign object-driving corridor association expediently also includes a static association between foreign objects 6 and driving corridor 5. A static association is to be understood as the allocation of foreign objects 6 that are static relative to driving corridor 5.

The roadway information may be available in point lists or as polygon chains, also known as splines, which describe the roadway extension and driving corridor 5 in corresponding image coordinates. As shown in FIG. 2, foreign objects 6 are able to be represented by associated so-called bounding boxes 8, which make the position and extension of associated foreign object 6 available in image coordinates.

In the following text, the method for ascertaining the dynamic association will be described by way of example with reference to FIG. 3. In an advantageous manner, the method is executed using an appropriately developed computer program product.

As shown by dashed lines in FIG. 3, images 4 generated by image sensor 2 are supplied on a continuous basis. In a method measure 100, images 4 are used to ascertain driving corridor 5 in the native measuring space, as described above. Method measure 100 will also be referred to as track measure 100 in the following text. In addition to ascertaining driving corridor 5, track measure 100 advantageously also includes the ascertainment of the entire drivable area as well as its topology. In a further method measure 101, images 4 are utilized and, as described above, foreign objects 6 are detected in the native measuring space. This method measure 101 will also be referred to as a foreign object measure 101 in the following text. In addition, in a method measure 102, at least one kinematic variable is ascertained for foreign objects 6 with the aid of images 4 and in the native measuring space. This method measure 102 is also referred to as kinematic measure 102 in the following text. In the illustrated exemplary embodiment, the ego movement of ego vehicle 1 is furthermore ascertained in a method measure 103 with the aid of images 4 and in the native measuring space. Hereinafter, this method measure 103 is also referred to as ego movement measure 103. In an advantageous manner, ego movement measure 103 includes the ascertainment of translatory and rotatory ego movements of ego vehicle 1. The result of ego movement measure 103 is taken into consideration in kinematic measure 102. This means that the at least one kinematic variable is ascertained in the native measuring space, for which the ego movement of ego vehicle 1 is considered. The results of method measures 100 to 103 are made available to a following method measure 104 for ascertaining at least one dynamic foreign object-driving corridor association, as described above. Method measure 104 will also be referred to as association measure 104 in the following text. The result of association measure 104, as described above and shown in FIG. 3 by two fields within association measure 104, includes both the association of foreign objects 6 that are moving relative to driving corridor 5 and the static association. As shown in FIG. 3, the result of association measure 104 is able to be made available to a driver assistance system 9 of ego vehicle 1. With the aid of driver assistance system 9, assistance for a vehicle driver (not shown) can be realized and an at least semiautomated driving of ego vehicle 1 is able to be implemented. Driver assistance system 9, for example, may include an adaptive cruise control and/or an autonomous emergency braking function.

At least one of the ascertained kinematic variables is advantageously the lateral velocity of foreign object 6 relative to driving corridor 5, preferably relative to a boundary of driving corridor 5. That means that a velocity of foreign object 6 transversely or at an angle to driving corridor 5 is ascertained with the aid of images 4 and in the native measuring space. To ascertain the lateral velocity, a velocity signal is advantageously derived from the movement of bounding box 8 associated with foreign object 6 in the image plane over time. Taking the ego movement of ego vehicle 1 into account, the relative movement of foreign object 6 with respect to driving corridor 5, especially to boundaries of driving corridor 5, and thus the lateral velocity, is able to be ascertained. In the same way, a movement direction 10 (see FIG. 2) of foreign object 6 is ascertainable as a kinematic variable. In an advantageous manner, a distance of foreign object 6 from driving corridor 5, in particular from boundaries of driving corridor 5, is ascertained as a further kinematic variable. For instance, this is accomplished by measuring the distance in pixels between the splines and the associated bounding box 8. This may involve the lateral distance of foreign object 6 from the boundary of driving corridor 5. With the aid of the distance, the static association can particularly also be implemented in a simplified manner. As an alternative or in addition, kinematic variables can also be ascertained with the aid of the optical flow.

The respective dynamic association may be one such form, provided it describes and/or includes a dynamic relation between driving corridor 5 and associated foreign object 6.

$$T T E C = \frac{d}{{v}_{l}} ,$$

In the exemplary embodiment shown in FIG. 2, a time period in which foreign object 6 enters driving corridor 5 is ascertained as a dynamic association. The entry period is also known under its English name “time-to-enter corridor”, abbreviated as “TTEC”. Foreign object 6 is located outside of driving corridor 5. In a simple case of a uniform movement of foreign object 6, the time-to-enter corridor corresponds to a uniform movement of foreign object 6 in relation to the distance of foreign object 6 from a boundary of driving corridor 5 and the lateral velocity:

$$T T E C = \frac{d}{{v}_{l}} ,$$

where d is the distance, and vₗ is the lateral velocity.

In a similar manner, a time-to-leave corridor in which foreign object 6 leaves driving corridor 5 is able to be ascertained for a foreign object 6 (not shown) which is located within driving corridor 5. The time-to-leave is also known under its English name “time-to-leave corridor”, abbreviated as “TTLC”.

$$T T E C = \frac{d}{{v}_{l}} ,$$

In an advantageous manner, based on the time-to-enter corridor or the time-to-leave corridor, probabilities of foreign object 6 entering driving corridor 5 or of foreign object 6 leaving driving corridor 5 are ascertained. For this purpose, at least one geometrical variable of foreign object 6 is advantageously utilized, and an entry probability of foreign object 6 entering driving corridor 5 is ascertained with the aid of the at least one geometrical variable and the time-to-enter corridor, and/or an exit probability of foreign object 6 exiting driving corridor 5 is ascertained with the aid of the at least one geometrical variable and the time-to-leave corridor. Such a geometrical variable, for example, is the angle between the predicted object trajectory of foreign object 6 and driving corridor 5, in particular a boundary of driving corridor 5.

In addition, a plausibility check for the entering or leaving of foreign object 6 is able to be utilized. Such a plausibility check advantageously includes further information relating to foreign object 6 such as a turn signal of a third-party vehicle (not shown) as a foreign object 6.

What is claimed is:

1. A method for ascertaining a dynamic foreign object-driving corridor association using an image sensor of an ego vehicle, the method comprising the following steps:
generating images of an environment of the ego vehicle using the image sensor;
using the images in a native measuring space of the image sensor, performing:
ascertaining a driving corridor of the ego vehicle along which the ego vehicle will be moving from roadway information and/or using odometry,
detecting foreign objects, and
ascertaining at least one kinematic variable is ascertained for at least one of the foreign objects; and
based on the at least one kinematic variable and the driving corridor, ascertaining at least one dynamic foreign object-driving corridor association for a lateral movement of the foreign object.

2. The method as recited in claim 1, wherein a lateral velocity of the foreign object relative to the driving corridor is ascertained as one of the at least one kinematic variable.

3. The method as recited in claim 2, wherein a bounding box is assigned to the foreign object in the native measuring space, a movement of the bounding box is tracked over time and the lateral velocity of the foreign object relative to the driving corridor is ascertained from the movement.

4. The method as recited in claim 2, wherein an ego movement of the ego vehicle is utilized, and based on the velocity, a relative movement of the foreign object with regard to the driving corridor is ascertained as a dynamic foreign object-driving corridor association of the at least one dynamic foreign object-driving corridor association.

5. The method as recited in claim 1, wherein a distance of the foreign object from the driving corridor is ascertained as a kinematic variable of the at least one kinematic variable.

6. The method as recited in claim 1, wherein:
foreign objects that are located outside of the driving corridor are detected in the native measuring space,
a time-to-enter corridor at which the foreign object enters the driving corridor is ascertained as a dynamic foreign object-driving corridor association of the at least one dynamic foreign object-driving corridor association.

7. The method as recited in claim 1, wherein:
foreign objects that are located within the driving corridor are detected in the native measuring space,
a time-to-leave corridor at which the foreign object leaves the driving corridor is ascertained as a dynamic foreign object-driving corridor association of the at least one dynamic foreign object-driving corridor association.

8. The method as recited in claim 6, wherein a ratio of s distance of the foreign object from a boundary of the driving corridor and the lateral velocity is ascertained as the time-to-enter corridor.

9. The method as recited in claim 7, wherein:
at least one geometrical variable of the foreign object is used, an exit probability of the foreign object leaving the driving corridor is ascertained using the at least one geometrical variable and the time-to-leave corridor.

10. The method as recited in claim 1, wherein the at least one dynamic foreign object-driving corridor association is made available to a driver assistance system of the ego vehicle.

11. A non-transitory computer-readable medium on which is stored a computer program for ascertaining a dynamic foreign object-driving corridor association using an image sensor of an ego vehicle, the computer program, when executed by a computer, causing the computer to perform the following steps:
generating images of an environment of the ego vehicle using the image sensor;
using the images in a native measuring space of the image sensor:
ascertaining a driving corridor of the ego vehicle along which the ego vehicle will be moving from roadway information and/or using odometry,
detecting foreign objects,
ascertaining at least one kinematic variable is ascertained for at least one of the foreign objects; and
based on the at least one kinematic variable and the driving corridor, ascertaining at least one dynamic foreign object-driving corridor association for a lateral movement of the foreign object.
